(19) United States
(12) Patent Application Publication
(10) Pub. No.: US 2026/0134557 A1
(43) Pub. Date: May 14, 2026

(54) INTELLIGENT MOBILE TERMINAL

(71) Applicant: TRIPLE WIN TECHNOLOGY (SHENZHEN) CO.LTD., Shenzhen (CN)

(72) Inventor: HSUAN-WEI HO, New Taipei (TW)

(21) Appl. No.: 19/247,183

(22) Filed: Jun. 24, 2025

(30) Foreign Application Priority Data
Nov. 14, 2024 (CN) 202411625501.9

(51) Int. Cl. G06T 7/521; G01B 11/25; G06T 7/55

(52) U.S. Cl. CPC G06T 7/521; G01B 11/25; G06T 7/55; G06T 2207/10028; G06T 2207/20056

(57) ABSTRACT

An intelligent mobile terminal includes an image capture module, a scanning module, and a controller. The scanning module includes a projection module configured to project structured light. The controller is electrically coupled to each of the projection module and the image capture module. The image capture module is configured to capture scanning images formed by the structured light projected onto surfaces of a test object. The controller is used to construct three-dimensional point cloud data of the test object based on the scanning images.

### FIELD

The subject matter herein relates to a field of intelligent mobile terminal technology, particularly to an intelligent mobile terminal.

### BACKGROUND

The use of structured light to measure the three-dimensional contour of objects has the advantages of non-contact, high accuracy, and fast measurement speed. It can be used for the reconstruction of three-dimensional models of objects and the detection of size and shape parameters in industrial environment. However, current devices for measuring the three-dimensional contour of objects not only have poor portability, but also have relatively limited functions.

Therefore, there is room for improvement in the art.

### BRIEF DESCRIPTION OF THE DRAWINGS

Implementations of the present technology will now be described, by way of embodiments only, with reference to the attached figures.

FIG. 1 is a schematic view showing an optical path of an intelligent mobile terminal according to an embodiment of the present disclosure.

FIG. 2 is a schematic view showing another optical path when the intelligent mobile terminal projects image light, according to an embodiment of the present disclosure.

FIG. 3 is a schematic view showing an optical path of a projection module and an image capture module according to a first embodiment of the present disclosure.

FIG. 4A, FIG. 4B, and FIG. 4C are schematic views of fringe patterns when the projection module projects structured light onto a test object for a first time, a second time, and a third time, respectively.

FIG. 5 is a schematic view of a 3D point cloud acquired by the intelligent mobile terminal in an embodiment of the present disclosure.

FIG. 6 is a schematic view illustrating a projection module according to a second embodiment of the present disclosure project structured light.

FIG. 7 is a schematic view showing an optical path of a light-guiding module according to a second embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein.

However, it will be understood by those of ordinary skill in the art that the embodiments described herein may be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “coupled” is defined as coupled, whether directly or indirectly through intervening components, and is not necessarily limited to physical connections. The connection can be such that the objects are permanently coupled or releasably coupled. The term “comprising” when utilized, means “including, but not necessarily limited to”; it specifically indicates open-ended inclusion or membership in the so-described combination, group, series, and the like.

### First Embodiment

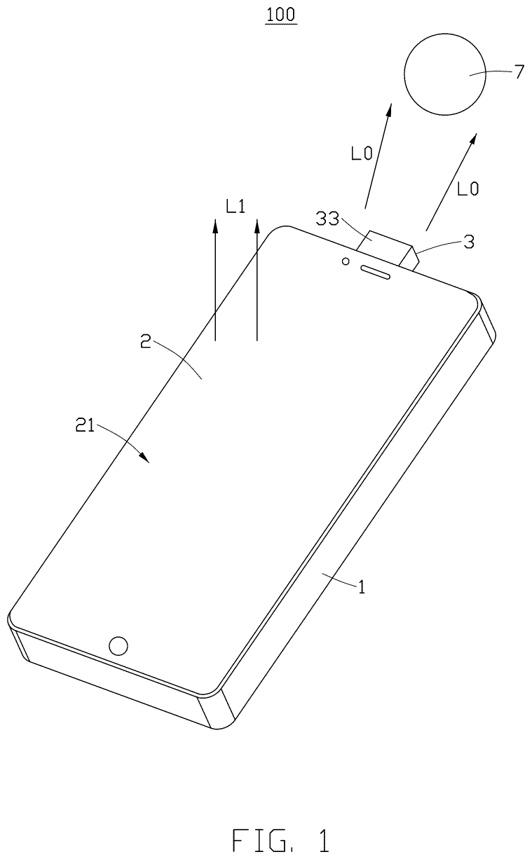

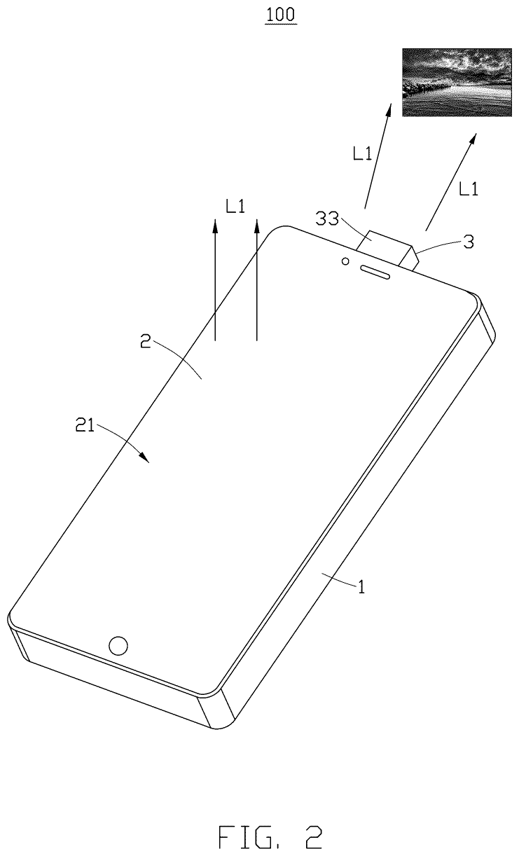

FIG. 1 to FIG. 3 illustrates an intelligent mobile terminal 100 according to an embodiment of the present disclosure. The intelligent mobile terminal 100 includes a housing 1, a display module 2, scanning module 3, an image capture module 4, and a controller 5. The display module 2, the scanning module 3, the image capture module 4, and the controller 5 are disposed in the housing 1. The display module 2 is configured to display images, enabling users touch operations based on the displayed images. Both the scanning module 3 and the image capture module 4 are electrically connected to the controller 5.

In this embodiment, the intelligent mobile terminal 100 is a phone. The intelligent mobile terminal may further include a communication module (not shown) and a microphone (not shown) both electrically connected to the controller 5. Through touch operations performed by the user based on images displayed by the display module 2, the controller 5 controls the communication module and microphone to realize users' needs for making and receiving phone calls. In other embodiments, the intelligent mobile terminal 100 may alternatively be a tablet computer, a portable multimedia player, a miniaturized computing device, or the like.

The housing 1 can be made of metal, glass, or plastic. The housing 1 is used to fix the display module 2, the scanning module 3, the image capture module 4, and the controller 5 to enhance stability of the intelligent mobile terminal 100 during operation. The housing 1 can also be equipped with a front camera (not shown), a flashlight (not shown), a USB interface (not shown), and a speaker (not shown) according to the user's needs, to meet the diverse functional requirements of users.

The display module 2 includes a glass cover plate 21 and a display assembly (not shown) attached to the glass cover plate 21. The display module 2 is used to emit image light L1. The display module 2 can be any one of a liquid crystal display, a light emitting diode display, an organic light emitting diode display, or a micro light emitting diode display. The controller 5 is used to transmit image data to the display module 2. In this embodiment, the video call request received by the intelligent mobile terminal 100 can also be output to the display module 2 for display by the controller 5, thereby achieving the video call function of the intelligent mobile terminal 100.

The scanning module 3 includes a projection module 31 and a support member 33 configured for fixing the projection module 31. The projection module 31 is used to project/emit structured light L0 onto a test object 7 multiple times. In some embodiments, the projection module 31 may be a projector. Specifically, the projection module 31 includes a projection light source (not shown) and a light guiding component (not shown). The projection light source is used to emit light, and the light guiding component is used to receive and project light. The projection light source is any one of high-pressure gas discharge light sources such as ultra-high pressure mercury lamps, halogen light, light-emitting diodes, and liquid crystal displays. The light guiding component includes a plurality of lenses, which are used to receive and project the structured light L0. In this embodiment, the projection module 31 is also used to project image light L1 to form a projection image. In other embodiments, the projection module 31 may only be used for projecting the structured light L0. The support member 33 can be made of metal, plastic, or glass. By setting up the support member 33, it is beneficial to further enhance the stability of the scanning module 3 in projecting structured light L0 or image light L1, thereby improving the stability of the intelligent mobile terminal 100 when scanning the contour of objects in 3D.

The structured light L0 is projected onto the test object 7 to form a striped pattern with alternating light and dark. The image capture module 4 is used to capture scanned images formed by the structured light L0 projected onto the surface of the test object 7, that is, to obtain grayscale values of the striped pattern with alternating light and dark. In this embodiment, the image capture module 4 is a camera on the intelligent mobile terminal 100, and the image capture module 4 can also be used to take photos or videos according to user needs. Specifically, the display module 2 displays images for users to perform touch operations based on content of the displayed images, thereby the controller 5 to obtain scanned images formed by projecting the structured light L0 onto surface of the test object 7 by the image capture module 4, or to take photos or videos according to user needs. In other embodiments, the image capture module 4 can be a camera separately mounted on the mobile phone for scanning the test object 7.

The stripe pattern formed by the structured light L0 is configured as a periodic grating stripe pattern with grayscale distributed according to a sine function. The phase shift of the stripe patterns has a range from −π/2 to π/2. Specifically, the phase shift of the stripe pattern can be any value within a range from −π/2 to −π/3, a range from −π/3 to 0, a range from 0 to π/3, or a range from π/3 to π/2, and the phase shift of the stripe pattern can be taken as a terminal value.

In this embodiment, the projection module 31 projects the structured light L0 onto the test object 7 three times to form three stripe patterns on the test object 7. The grayscale formulas for the three stripe patterns are as follows.

$${I}_{1} ( x , y ) = {I}^{′} ( x , y ) + {I}^{″} ( x , y ) cos [ φ ( x , y ) - 2 π / 3 ] \qquad ( 1 )$$

$${I}_{2} ( x , y ) = {I}^{′} ( x , y ) + {I}^{″} ( x , y ) cos [ φ ( x , y ) ] \qquad ( 2 )$$

$$\begin{matrix}{I}_{3} ( x , y ) = {I}^{′} ( x , y ) + {I}^{″} ( x , y ) cos [ φ ( x , y ) + 2 π / 3 ] & ( 3 )\end{matrix}$$

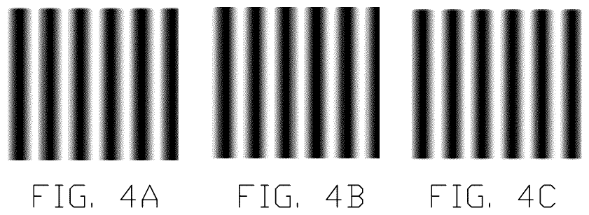

In the formula (1), I₁(x, y) represents the grayscale values of the stripe pattern obtained by the projection module 31 projecting the structured light L0 to the test object 7 for the first time. In the formula (2), I₂(x, y) represents the grayscale values of the stripe pattern obtained by the projection module 31 projecting the structured light L0 to the test object 7 for the second time. In the formula (3), I₃(x, y) represents the grayscale values of the stripe pattern obtained by the projection module 31 projecting the structured light L0 to the test object 7 for the third time. In the formulas (1), (2), and (3), I′ (x, y) is an average grayscale value of the stripe pattern, and I″(x, y) is a grayscale modulation value of the stripe pattern, φ(x, y) is the phase information of the test object 7 that needs to be solved. The phase shift of the stripe patterns obtained by projecting the structured light L0 three times onto the test object 7 by the projection module 31 is −π/3, 0, and +π/3, respectively. FIG. 4A shows the stripe pattern obtained by the projection module 31 projecting the structured light L0 to the test object 7 for the first time. FIG. 4B shows the stripe pattern obtained by the projection module 31 projecting the structured light L0 to the test object 7 for the second time. FIG. 4C shows the stripe pattern obtained by the projection module 31 projecting the structured light L0 to the test object 7 for the third time.

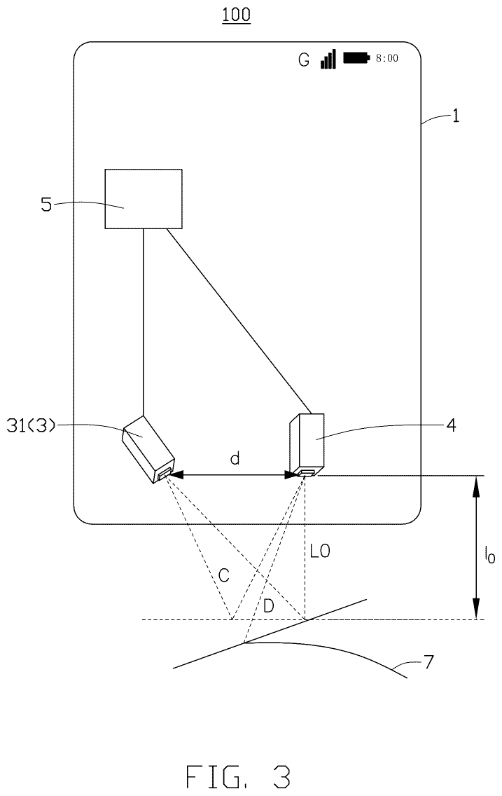

Please refer to FIG. 1, FIG. 3, and FIG. 4 again, and combine the formulas (1), (2), and (3), a formula (4) for the phase information φ(x, y) of the test object 7 that needs to be solved can be obtained as follow.

$$ϕ ( x , y ) = {tan}^{- 1} [ \frac{\sqrt{3} ( {I}_{1} - {I}_{3} )}{2 {I}_{2} - {I}_{1} - {I}_{3}} ] \qquad ( 4 )$$

The controller 5 is electrically connected to both the projection module 31 and the image capture module 4. The controller 5 is used to construct three-dimensional point cloud data of the test object 7 based on the scanned images. Specifically, because the tangent function (tan⁻¹) is a discontinuous function, restored phase values are in a discontinuous state. In order to combine the restored discontinuous states to obtain a continuous phase distribution, the controller 5 uses Euler's formula to unwrap the phase information φ(x, y) obtained from the formula (4) to obtain the phase of the striped pattern modulated by the test object 7. That is, the phase information of the test object 7 is obtained by solving the inverse trigonometric function.

Before the intelligent mobile terminal 100 leaves preparing factory, it is necessary to calibrate the positions of the projection module 31 and the image capture module 4 by manually setting a reference plane to obtain a function mapping relationship between the projection module 31 and the image capture module 4. FIG. 3 is a schematic view of the relative positions of the projection module 31 and the image capture module 4 of the intelligent mobile terminal 100 provided in this embodiment. The projection module 31 and the image capture module 4 are located on a same horizontal plane. A distance between the projection module 31/the image capture module 4 and the reference plane is defined as I₀, and the distance between the projection module 31 and the image capture module 4 is defined as d. If the structured light L0 is projected onto the reference plane, the stripe pattern is imaged at point C, and the image capture module 4 is also imaged at point C. However, due to the test object 7, the stripe pattern is only reflected at point D on the surface of the test object 7. Therefore, the change in the reflection position causes the light spot to move a distance of C̅D̅ on the plane of the image capture module 4. According to the geometric relationship, the formula (5) between the optical path difference C̅D̅ and the height information h(x, y) of the test object can be obtained as follows.

$$\overline{CD} = \frac{- dh ( x , y )}{[ {l}_{o} - h ( x , y ) ]} \qquad ( 5 )$$

The relationship between the optical path difference CD and the phase difference Δφ(x, y) is expressed as formula (6).

$$Δ ϕ ( x , y ) = ϕ ( x , y ) - {ϕ}_{0} ( x , y ) = 2 π {f}_{0} \overline{CD} \qquad ( 6 )$$

φ(x, y) is the phase information of the test object 7 that needs to be solved, φ₀ (x, y) is the phase information of the test object 7 on the reference plane, and f₀ is the frequency of the structured light L0. A functional relationship formula (7) between the phase difference of the test object 7 that needs to be solved and height information can be obtained by combining formulas (1) to (6).

$$h ( x , y ) = \frac{{l}_{o} Δφ ( x , y )}{Δφ ( x , y ) - 2 π {f}_{0} d} \approx - \frac{{l}_{o} Δφ ( x , y )}{2 π {f}_{0} d} = - \frac{{l}_{o} {p}_{0} Δφ ( x , y )}{2 π d} \qquad ( 7 )$$

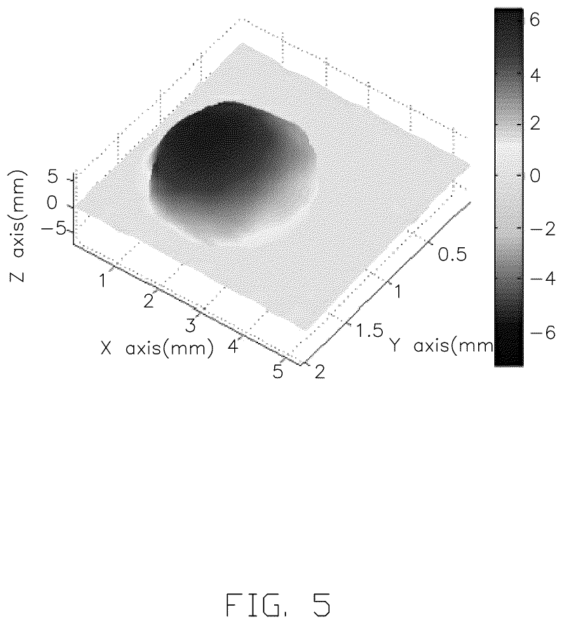

In the formula (7), p₀ is a period of the structured light L0 that be projected, where I₀, f₀, d, and p₀ are known parameters. By using the formula (7), the position information h(x, y) of the test object 7 relative to the projection module 31 and the image capture module 4 can be obtained. That is, the controller 5 can construct a three-dimensional point cloud data of the test object 7. A surface morphology (three-dimensional point cloud data) of the test object 7 is shown in FIG. 5.

The controller 5 is used to supply power and transmit image data to the display module 2. The controller 5 is also used to control the projection module 31 to project the structured light L0 or the image light L1 according to user operations. The controller 5 can be any one of a controller including RS485 interface, a central processing unit (CPU), and a microcontroller (such as STM32 microcontroller, 51 microcontroller, TMS microcontroller, PIC microcontroller, or AVR microcontroller).

The intelligent mobile terminal 100 provided in the first embodiment of the present disclosure includes the scanning module 3, the image capture module 4, and the controller 5. The scanning module 3 is used to project the structured light L0, the image capture module 4 is used to capture the scanned images formed by the structured light L0 projected onto surfaces of the test object 7, and the controller 5 is used to construct the three-dimensional point cloud data of the test object 7 based on the scanned images, which can effectively obtain the three-dimensional point cloud data of the test object 7. When the image capture module 4 is a camera installed on a mobile phone, it can simultaneously meet the requirements of users to project images and measure the three-dimensional contour of the test object 7, which is conducive to improving an overall portability of the intelligent mobile terminal 100. It is also conducive to achieving the measurement of the three-dimensional contour of the test object 7, and beneficial to diversify the functions of the intelligent mobile terminal 100, thereby improving the user experience.

### Second Embodiment

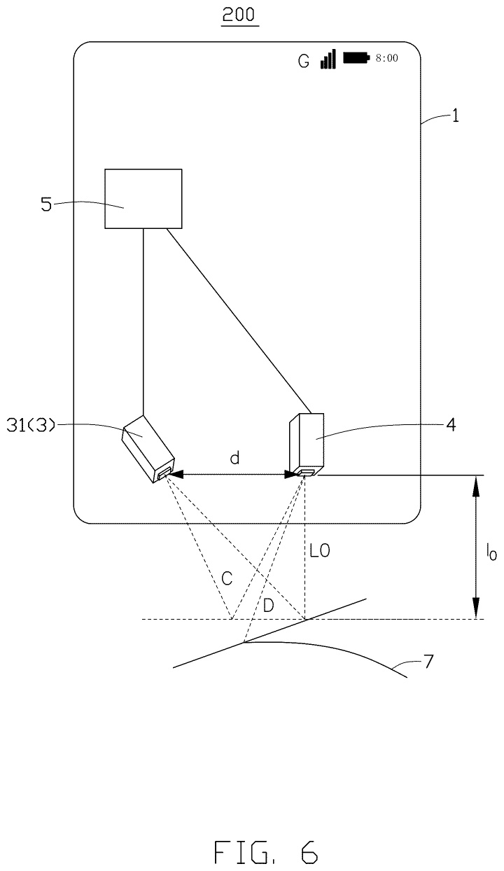

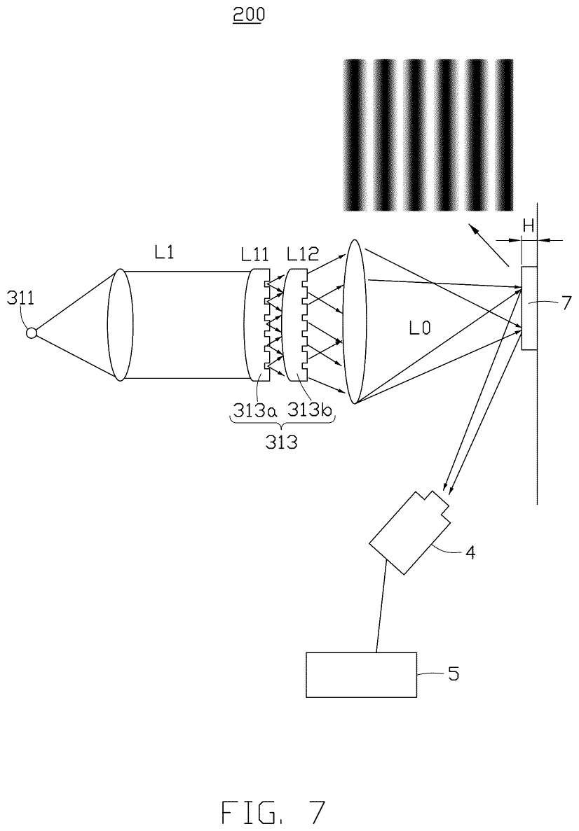

FIG. 6 and FIG. 7 illustrate an intelligent mobile terminal 200 of a second embodiment. The intelligent mobile terminal 200 includes a housing 1, a display module 2, a scanning module 3, an image capture module 4, and a controller 5. The display module 2, the scanning module 3, the image capture module 4, and the controller 5 are installed in the housing 1. The display module 2 is used to display images for users to perform touch operations based on content of displayed images. Both the scanning module 3 and the image capture module 4 are electrically connected to the controller 5. A difference between the intelligent mobile terminal 200 and the intelligent mobile terminal 100 of the first embodiment is that the projection module 31 in the intelligent mobile terminal 200 includes a light source 311 and a light modulator 313. The light source 311 is used to emit a first light L1, and the light modulator 313 is used to modulate the first light L1 into structured light L0 having a preset frequency.

In this embodiment, the first light L1 is laser. In other embodiments, the first light L1 is any other non laser light. The light source 311 can be any one of the high-pressure gas discharge light source, a light emitting diode, or a liquid crystal display screen. The high-pressure gas discharge light source can be such as an ultra-high pressure mercury lamp, or a halogen light.

The light modulator 313 includes a first diffraction element 313a and a second diffraction element 313b. The first diffraction element 313a is used to receive the first light L1 and modulate the first light L1 into a first structured light L11. The first structured light L11 partially passes through the second diffraction element 313b. The second diffraction element 313b is used to receive a portion of the first structured light L11 and modulate the portion of the first structured light L11 into a second structured light L12 having a second predetermined frequency. The first structured light L11 and the second structured light L12 are superimposed to form a structured light L0 having a predetermined frequency.

The projection module 31 is used to project structured light L0 with a preset frequency f₀ onto the test object 7 to form stripe information on the surface of the test object 7. The structured light L0 with a preset frequency is formed by superimposing a first structured light L11 with a first preset frequency and a second structured light L12 with a second preset frequency. The light modulator 313 is also used to superimpose the first structured light L11 and the second structured light L12 to form a structured light L0 with a preset frequency, and project the structured light L0 with the preset frequency onto the test object 7.

The controller 5 is used to obtain a spectral image based on stripe information. The spectral image is used to obtain a first phase information of the first structured light L11, a second phase information of the second structured light L12, and equivalent phase information of the structured light L0. The first phase information, the second phase information, and the equivalent phase information are used to obtain height information of the test object relative to the intelligent mobile terminal 200, in order to obtain three-dimensional point cloud data.

Specifically, the controller 5 generates the following formula (8) based on deformed stripes in the stripe image:

$$I ( x , y ) = a ( x , y ) + {b}_{1} ( x , y ) cos [ 2 π ( {f}_{1 x} x + {f}_{1 y} y ) + {φ}_{1} ( x , y ) ) ] + {b}_{2} ( x , y ) cos [ 2 π ( {f}_{2 x} x + {f}_{2 y} y ) + {φ}_{2} ( x , y ) ) ] + {b}_{3} ( x , y ) cos [ 2 π ( {f}_{3 x} x + {f}_{3 y} y ) + {φ}_{3} ( x , y ) ) ] \qquad ( 8 )$$

(x, y) represents coordinates of the stripe image, and x is a numerical value of the column of the image coordinate and y is a numerical value of the row of the image coordinate. I (x, y) represents light intensity of the obtained spectral image, that is the grayscale value of the stripe image. a (x, y) is an average background light intensity of the image, and bₙ (x, y) is a variation amplitude of the stripe light intensity; [2π(fₙₓ+f_{ny})+φₙ (x, y)] is a carrier phase. φₙ(x, y) is the phase information. When n=1, it represents the phase information formed by the structured light L0 at the first frequency. When n=2, it represents the phase information formed by the structured light L0 at the second frequency. When n=3, it represents the phase information formed by the structured light L0 at the preset frequency.

Next, the formula (8) can be expanded into the following formula (9).

$$I ( x , y ) = {c}_{1} ( x , y ) exp [ j {φ}_{α} ( x , y ) ] + {c}_{1}^{*} ( x , y ) exp [ - j {φ}_{α} ( x , y ) ] + {c}_{2} ( x , y ) exp [ j {φ}_{β} ( x , y ) ] + {c}_{2}^{*} ( x , y ) exp [ - j {φ}_{β} ( x , y ) ] + {c}_{3} ( x , y ) exp [ j {φ}_{γ} ( x , y ) ] + {c}_{3}^{*} ( x , y ) exp [ - j {φ}_{γ} ( x , y ) ] \qquad ( 9 )$$

$$Wherein {C}_{n} ( x , y ) = \frac{1}{2} {b}_{n} ( x , y ) exp [ - j {φ}_{n} ( x , y ) ] .$$

The controller 5 is also used to obtain the spectral images through Fourier transform. Specifically, the formula (9) is Fourier transformed to obtain a spectral image, which has a spectral region related to the surface contour of the test object 7. The spectral image carries spectral information, and the spectral information Cₙ(x, y) is given by formula (10).

$${c}_{n} ( x , y ) = \frac{1}{2} b ( x , y ) [ cos ( φ ) + j sin ( φ ) ] \qquad ( 10 )$$

When n=1, it represents the spectral information formed by the structured light L0 having the first frequency, when n=2, it represents the spectral information formed by the structured light L0 having the second frequency, and when n=3, it represents the spectral information formed by the structured light L0 having the preset frequency.

The controller 5 is also used to obtain spectral information in the spectral region by a filter. In this embodiment, the spectral information in the spectral image is read through a diamond filter. In other embodiments, elliptical filters or Gaussian filters can also be used.

The controller 5 converts the frequency spectrum information of a first preset frequency, a second preset frequency, and a preset frequency into phase information through inverse Fourier transform, obtaining the first phase information, the second phase information, and equivalent phase information, respectively. The formulas for the first phase information, the second phase information, and the equivalent phase information are as follows.

$${φ}_{1} = {tan}^{- 1} [ \frac{Im [ c 1 ]}{Re [ c 1 ]} ] \qquad ( 11 )$$

$${φ}_{2} = {tan}^{- 1} [ \frac{Im [ c 2 ]}{Re [ c 2 ]} ] \qquad ( 12 )$$

$${φ}_{eq} = {tan}^{- 1} [ \frac{Im [ ceq ]}{Re [ ceq ]} ] \qquad ( 13 )$$

The controller 5 obtains a contour height of the test object 7 based on the first phase, the second phase, and the equivalent phase. The distance between the projection module 31/the image capture module 4 and the reference plane is/o. The distance between the projection module 31 and the image capture module 4 is defined as d. The functional relationship between the phase difference of the test object 7 that needs to be solved and height information can be obtained as formula (14):

$$h ( x , y ) = \frac{{l}_{o} Δφ ( x , y )}{Δφ ( x , y ) - 2 π {f}_{0} d} \approx - \frac{{l}_{o} Δφ ( x , y )}{2 π {f}_{0} d} = - \frac{{l}_{o} {p}_{0} Δφ ( x , y )}{2 π d} \qquad ( 14 )$$

In the formula (14), p₀ is a period of the projected structured light L0, where I₀, f₀, d, and p₀ are known parameters. By using the formula (14), the position information h(x, y) of the test object 7 relative to the projection module 31/the image capture module 4 can be obtained. That is, the controller 5 can construct the three-dimensional point cloud data of the test object 7. Specifically, the controller 5 is also used to reconstruct the surface morphology of the test object 7 based on the Euler formula, phase restoration technique, and contour height. Because the tangent function (tan⁻¹) is a discontinuous function, the reconstructed phase values are in a discontinuous state. In order to combine the restored discontinuous states to obtain a continuous phase distribution, it is necessary to use the Euler transform and phase unwrapping technique to restore the continuous phase, and then reconstruct the surface morphology of the test object 7. The surface morphology of the test object 7 (three-dimensional point cloud data) is shown in FIG. 5.

The intelligent mobile terminal 200 provided in the second embodiment of the present disclosure includes the scanning module 3, the image capture module 4, and the controller 5. The scanning module 3 is used to project structured light L0, the image capture module 4 is used to capture the scanned image formed by the structured light L0 projected onto the surface of the test object 7, and the controller 5 is used to construct the three-dimensional point cloud data of the test object 7 based on the scanned images, which can effectively obtain the three-dimensional point cloud data of the test object 7. When the image capture module 4 is a camera installed on a mobile phone, it can simultaneously meet the requirements of users to project images and measure the three-dimensional contour of the test object 7, which is conducive to improving the overall portability of the intelligent mobile terminal 200. It is also conducive to achieving the measurement of the three-dimensional contour of the test object 7, and beneficial to diversify the functions of the intelligent mobile terminal 100, thereby improving the user experience.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. An intelligent mobile terminal comprising:
an image capture module;
a scanning module comprising a projection module configured to project structured light;
a controller electrically coupled to each of the projection module and the image capture module,
wherein the image capture module is configured to capture scanning images formed by the structured light projected onto surfaces of a test object, and the controller is configured to construct three-dimensional point cloud data of the test object based on the scanning images.

2. The intelligent mobile terminal of claim 1, wherein a striped pattern having alternating light and dark is obtained by the projection module projecting the structured light onto the surfaces of the test object.

3. The intelligent mobile terminal of claim 2, wherein the projection module is configured to project the structured light onto the surfaces of the test object for a plurality of times thereby forming the stripe pattern each time the projection module projects the structure light onto the surfaces of the test object; the stripe pattern formed by the structured light is configured as a periodic grating stripe pattern with gray scale distributed according to a sine function; a range of a phase shift of the stripe pattern is (−π/2,+π/2).

4. The intelligent mobile terminal of claim 3, wherein the projection module is configured to project the structured light onto the surfaces of the test object three times to form a first stripe pattern having the phase shift of −π/3, a second stripe pattern having the phase shift of zero (0), and a third stripe pattern having the phase shift of +π/3, respectively.

5. The intelligent mobile terminal of claim 1, further comprising a display module, wherein the display module emits image light, the controller is configured to transmit image data to the display module, and to control the projection module to project the structured light or the image light according to operation input.

6. The intelligent mobile terminal of claim 1, wherein the projection module comprises a light source and a light modulator;
the light source emits a first light, and the light modulator modulates the first light into the structured light having a preset frequency;
the projection module projects the structured light having the preset frequency onto surfaces of the test object thereby forming stripe information on the surfaces of the test object.

7. The intelligent mobile terminal of claim 6, wherein the first light is laser.

8. The intelligent mobile terminal of claim 6, wherein the light modulator modulates the first light into the structured light having the preset frequency by superimposing a first structured light with a first preset frequency and a second structured light with a second preset frequency.

9. The intelligent mobile terminal of claim 8, wherein the light modulator further projects the structured light having the preset frequency onto the surfaces of the test object.

10. The intelligent mobile terminal of claim 9, wherein the controller is further configured to obtain a spectral image based on the stripe information, the spectral image comprises first phase information of the first structured light, second phase information of the second structured light, and equivalent phase information of the structured light;
the first phase information, the second phase information, and the equivalent phase information comprises height information of the test object relative to the intelligent mobile terminal, and the controller is configured to construct the three-dimensional point cloud data of the test object further based on the height information.

11. The intelligent mobile terminal of claim 10, wherein the controller is further configured to obtain the spectral image by Fourier transforming the stripe information.

12. The intelligent mobile terminal of claim 10, wherein the controller is further configured to convert spectral information of the first preset frequency, spectral information the second preset frequency, and the preset frequency of the structured light into phase information by inverse Fourier transform, and obtain the first phase information, the second phase information, and the equivalent phase information.

13. The intelligent mobile terminal of claim 9, wherein the light modulator comprises a first diffraction element and a second diffraction element;
the first diffraction element receives the first light and modulates the first light into the first structured light;
the second diffraction element receives a portion of the first structured light and modulates the portion of the first structured light into the second structured light having the second predetermined frequency;
the first structured light and the second structured light are superimposed to form the structured light having the predetermined frequency.

14. The intelligent mobile terminal of claim 1, wherein the image capture module is a camera.

15. The intelligent mobile terminal of claim 1, wherein the intelligent mobile terminal is a phone.

16. The intelligent mobile terminal of claim 1, wherein the projection module is a projector.
